(19) United States
(12) Patent Application Publication
(10) Pub. No.: US 2025/0286351 A1
(43) Pub. Date: Sep. 11, 2025

(54) DUST-PROOF FILTER STRUCTURE FOR POWER SUPPLY PANEL

(71) Applicant: Hong Liu Co., Ltd., Taichung (TW)

(72) Inventor: Mu-Chun LIN, Taichung (TW)

(21) Appl. No.: 18/596,053

(22) Filed: Mar. 5, 2024

(51) Int. Cl. H02B 1/015; B01D 39/18; B01D 46/00; B01D 46/10

(52) U.S. Cl. CPC H02B 1/015; B01D 39/18; B01D 46/0002; B01D 46/10

(57) ABSTRACT

A dust-proof filter structure for a power supply panel is disclosed. The dust-proof filter structure is mounted to a front of a panel of a power supply. The panel has at least one air inlet hole. The dust-proof filter structure includes two retaining plates locked on two sides of the front of the panel. A frame is connected between the retaining plates and located on the front of the panel. The frame has a window corresponding in position to the air inlet hole. A detachable filter cotton mesh is disposed in the window. Thus, the cooling air flowing into the power supply can be filtered to prevent the components inside the power supply from being contaminated, so as to prolong the service life of the power supply and maintain the normal operation of the components. Besides, the filter cotton mesh can be quickly mounted and easily removed for cleaning.

### FIELD OF THE INVENTION

The present invention relates to a power supply, and more particularly, to a dust-proof filter structure for a power supply panel.

### BACKGROUND OF THE INVENTION

In general, most of machines and equipment that use air for cooling have an internal fan to draw the external air via air inlet holes for cooling the internal parts. However, due to the deterioration of air quality, the air contains impurities, lint, dust and chemical substances, and the impurities are easy to accumulate on the parts. When electronic components and other related parts are exposed to dirt for a long time, they may malfunction or being damaged easily.

Especially for a power supply, it utilizes a fan inside the power supply to draw the external air via air inlet holes for heat dissipation of the internal electronic components. It is well known that the power supply includes many electronic components, such as circuit boards, capacitors, coils and power transistors, etc. If the electronic components are covered with dirt for a long time, in addition to being unable to dissipate heat effectively, they may lose functionality or malfunction. The power supply generally uses an internal fan to directly draw the external air via air inlets for heat dissipation, without any means to prevent dust from entering the power supply. Especially in poor environments such as factories, the pollution will be more serious after a long period of time.

Accordingly, the inventor of the present invention has devoted himself based on his many years of practical experiences to solve these problems.

### SUMMARY OF THE INVENTION

The primary object of the present invention is to provide a dust-proof filter structure for a power supply panel. Through the dust-proof filter structure, the cooling air flowing into the power supply can be filtered to prevent the components inside the power supply from being contaminated, so as to prolong the service life of the power supply and maintain the normal operation of the components. Besides, the dust-proof filter structure has a filter cotton mesh that can be quickly mounted and easily removed for cleaning.

In order to achieve the foregoing object, the present invention provides a dust-proof filter structure for a power supply panel. The dust-proof filter structure is mounted to a front of a panel of a power supply. The panel has at least one air inlet hole. The dust-proof filter structure comprises two retaining plates, a frame, and at least one filter cotton mesh. The two retaining plates are locked on left and right two sides of the front of the panel, respectively. The retaining plates each have an engaging piece on an inner side thereof. The frame is located on the front of the panel. Two sides of the frame have engaging holes corresponding to the engaging pieces of the retaining plates, respectively. The engaging pieces of the retaining plates are engaged in the respective engaging holes, so that the frame is combined with the retaining plates and secured to the front of the panel. The frame has at least one window corresponding in position to the air inlet hole. The window corresponds in shape to the air inlet hole. The filter cotton mesh corresponds in shape to the window and is disposed in the window.

### BRIEF DESCRIPTION OF THE DRAWINGS

FIG. 1 is an exploded view of a preferred embodiment of the present invention;

FIG. 2 is a perspective view of the preferred embodiment of the present invention;

FIG. 3 is a front view of the preferred embodiment of the present invention; and

FIG. 4 is a schematic view of the preferred embodiment of the present invention mounted to a rack.

### DETAILED DESCRIPTION OF THE PREFERRED EMBODIMENTS

Embodiments of the present invention will now be described, by way of example only, with reference to the accompanying drawings.

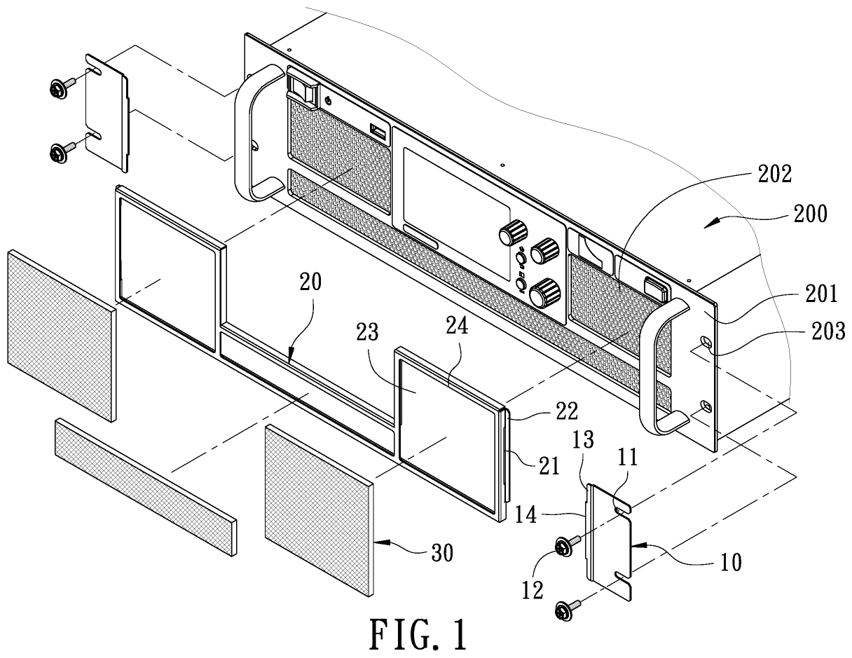

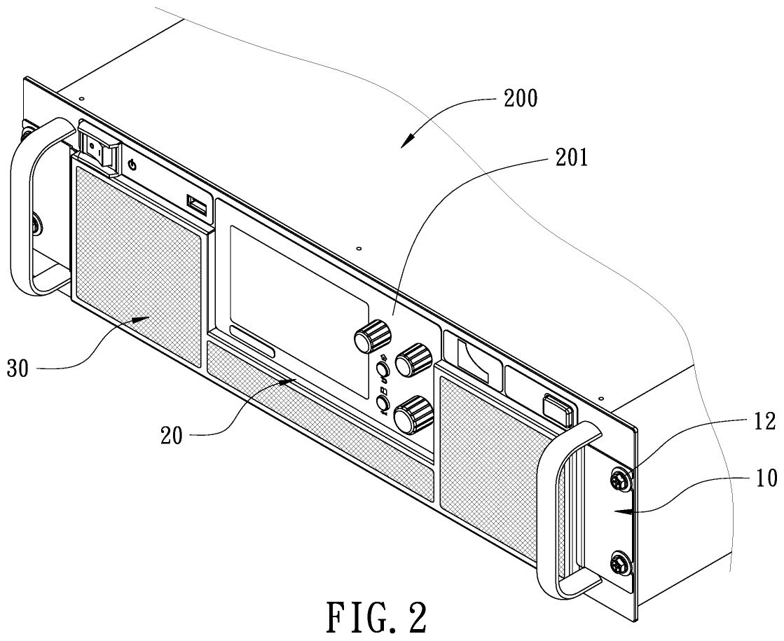

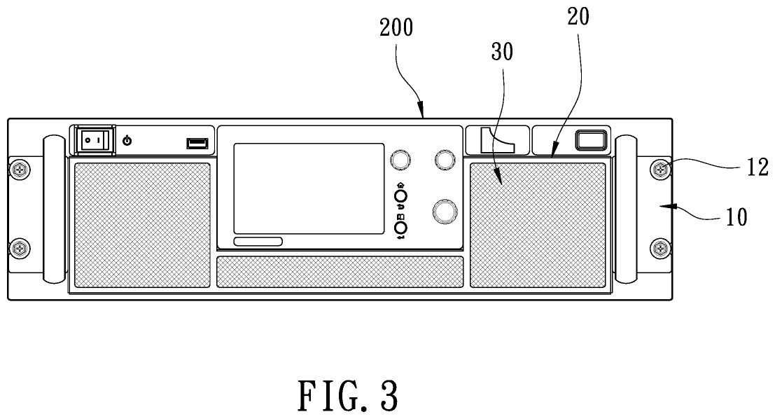

FIG. 1 is an exploded view of a preferred embodiment of the present invention. FIG. 2 is a perspective view of the preferred embodiment of the present invention. FIG. 3 is a front view of the preferred embodiment of the present invention. The present invention discloses a dust-proof filter structure for a power supply panel. The dust-proof filter structure is mounted to the front of a panel 201 of a power supply 200. The panel 201 has a plurality of air inlet holes 202 and a plurality of locking holes 203. The locking holes 203 are located the left and right two sides of the panel 201 for the panel 201 to be locked to a rack.

The dust-proof filter structure includes two retaining plates 10, a frame 20, and a plurality of filter cotton meshes 30.

The two retaining plates 10 are locked on the left and right two sides of the front of the panel 201, respectively. The retaining plates 10 are formed with a plurality of horizontal elongate holes 11 corresponding to the respective locking holes 203. The elongate holes 11 each have an open outer end, so that the retaining plates 10 can be mounted and dismounted easily. A plurality of bolts 12 lock the retaining plates 10 to the panel 201. The inner side of each retaining plate 10 is bent to form a vertical shoulder portion 13. The inner side of the shoulder portion 13 has an engaging piece 14.

The frame 20 is located on the front of the panel 201. Two sides of the bottom of the frame 20 extend outwardly to from vertical extension plates 22 corresponding to the shoulder portions 13 of the retaining plates 10, respectively. The extension plates 22 are inserted into and restricted by the shoulder portions 13 of the retaining plates 10, respectively. Two sides of the frame 20 have engaging holes 21 corresponding to the engaging pieces 14 of the retaining plates 10, respectively. The engaging pieces 14 of the retaining plates 10 are engaged in the respective engaging holes 21, so that the frame 20 is retained by the retaining plates 10 and secured to the front of the panel 201. The frame 20 has windows 23 corresponding in position to the air inlet holes 202. The windows 23 correspond in shape to the respective air inlet holes 202. The surface of the frame 20 has a stop edge 24 protruding from the periphery of the windows 23.

The filter cotton meshes 30 each have a flexible mesh body for filtering out impurities, lint and dust in the air. The filter cotton meshes 30 correspond in shape to the respective windows 23 and are inserted and placed in the windows 23. The filter cotton meshes 30 are confined by the stop edge 24, so as to be secured in the windows 23.

In order to further understand the structural features, the technical means and the expected effects of the present invention, the assembly and effects of the present invention are described hereinafter.

When the dust-proof filter structure provided by the present invention is to be mounted on the panel 201 of the power supply 200, first, the engaging pieces 14 of the retaining plates 10 are engaged in the respective engaging holes 21 on the two sides of the frame 20, so that the frame 20 is combined with the retaining plates 10. Then, the bolts 12 pass through the elongate holes 11 of the retaining plates 10 and are locked to the locking holes 203 of the panel 201. Thus, the frame 20 and the retaining plates 10 are secured to the front of the panel 201. Finally, the filter cotton meshes 30 are placed in the corresponding windows 23 respectively. Because the filter cotton meshes 30 are flexible, they can be slightly bent to be placed in the windows 23 and confined by the stop edges 24 to achieve a positioning effect, thereby completing the assembly of the dust-proof filter structure.

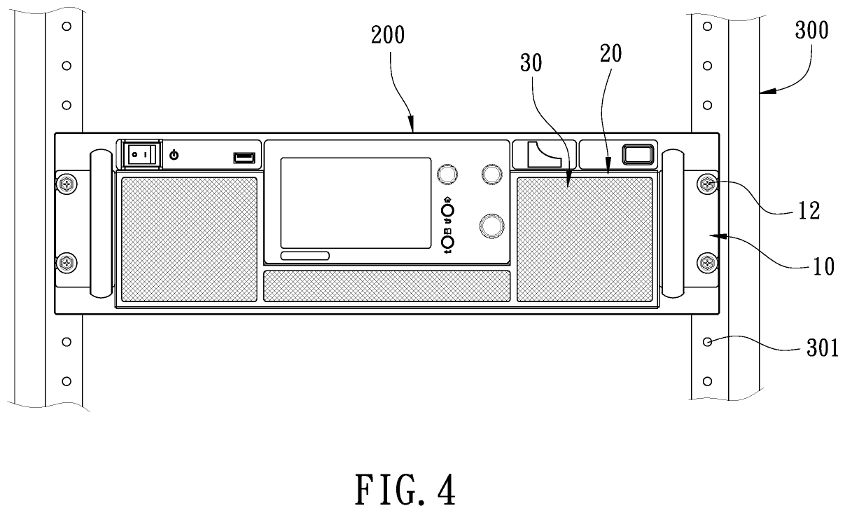

FIG. 4 is a schematic view of the preferred embodiment of the present invention mounted to a rack. When the power supply 200 of the present invention is to be installed on a rack 300, the bolts 12 are inserted through the elongate holes 11 of the retaining plates 10 and the locking holes 203 of the panel 201 and locked to positioning holes 301 of the rack 300.

From the above description, through the dust-proof filter structure provided by the present invention, the cooling air flowing into the power supply 200 can be filtered to prevent the components inside the power supply 200 from being contaminated, so as to prolong the service life of the power supply 200 and maintain the normal operation of the components. Besides, the filter cotton meshes 30 can be quickly mounted and easily removed for cleaning. In addition, since the anti-dust filter structure provided by the present invention is installed and secured via the locking holes 203 that are originally used for being secured to the rack 300, the panel of the power supply 200 does not need additional molding or locking holes, thereby saving the cost of materials.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dust-proof filter structure for a power supply panel, mounted to a front of a panel of a power supply, the panel having at least one air inlet hole, the dust-proof filter structure comprising:
two retaining plates, locked on left and right two sides of the front of the panel respectively, wherein the retaining plates each have an engaging piece on an inner side thereof;
a frame, located on the front of the panel, two sides of the frame having engaging holes corresponding to the engaging pieces of the respective retaining plates, the engaging pieces of the retaining plates being engaged in the respective engaging holes so that the frame is combined with the retaining plates and secured to the front of the panel, wherein the frame has at least one window corresponding in position to the air inlet hole, and the window corresponds in shape to the air inlet hole;
at least one filter cotton mesh, corresponding in shape to the window and being disposed in the window.

2. The dust-proof filter structure as claimed in claim 1, wherein two sides of the panel have a plurality of locking holes, a plurality of bolts pass through the locking holes for locking the power supply to a rack, the retaining plates are formed with a plurality of horizontal elongate holes corresponding to the respective locking holes for the bolts to lock the retaining plates to the panel.

3. The dust-proof filter structure as claimed in claim 2, wherein the elongate holes each have an open outer end.

4. The dust-proof filter structure as claimed in claim 1, wherein a surface of the frame has a stop edge protruding from a periphery of the window, so that the filter cotton mesh is confined by the stop edge to be secured in the window.

5. The dust-proof filter structure as claimed in claim 1, wherein the inner side of the retaining plate is bent to form a vertical shoulder portion, two sides of a bottom of the frame extend outwardly to from vertical extension plates corresponding to the shoulder portions of the retaining plates, and the extension plates are inserted into and restricted by the shoulder portions of the retaining plates, respectively.
